(19) United States
(12) Patent Application Publication
(10) Pub. No.: US 2026/0275561 A1
(43) Pub. Date: Sep. 17, 2026

(54) METHOD FOR TREATING PACKAGING FOR RADIOACTIVE MATERIAL AGAINST CORROSION

(71) Applicant: ORANO NUCLEAR PACKAGES AND SERVICES, Montigny-le-Bretonneux (FR)

(72) Inventors: Fanny RIALLANT, Plaisir (FR); Hervé RIPERT, Paris (FR); Grégory TEIXEIRA-MENDES, Les Pieux (FR)

(21) Appl. No.: 19/167,905

(22) PCT Filed: Mar. 22, 2024
(86) PCT No.: PCT/FR2024/050370

§ 371 Date: Sep. 23, 2025

(30) Foreign Application Priority Data
Mar. 24, 2023 (FR) 2302832

(51) Int. Cl. C25D 5/02; C25D 3/12; C25D 5/06; C25D 7/00; C25D 17/14; G21F 5/12

(52) U.S. Cl. CPC C25D 5/02; C25D 3/12; C25D 5/06; C25D 7/00; C25D 17/14; G21F 5/12

(57) ABSTRACT

Replacement Sheet A method for treating at least one surface of packaging for transporting, warehousing and/or storing radioactive material against corrosion, the surface being a surface intended to accommodate at least one seal of the packaging. The method is implemented by means of an electrolytic device including an anode, a cathode and an electrolytic solution, the electrolytic solution having at least one metal M in cationic form.

### TECHNICAL FIELD OF THE INVENTION

The invention relates to a method for treating packaging for radioactive material against corrosion.

The invention relates more particularly to a method for treating at least one surface of packaging for transporting, warehousing and/or storing radioactive material against corrosion. This surface advantageously corresponds to a surface intended to accommodate a seal provided on said packaging.

The invention also relates to packaging for transporting, warehousing and/or storing radioactive material comprising at least one surface treated against corrosion by the aforementioned anti-corrosion treatment method.

### PRIOR ART

From the methods for treating against corrosion known in the field of packaging for transporting, warehousing and/or storing radioactive material, mention may be made of the method consisting in forming an anti-corrosion coating, typically made of nickel, at least at the level of the cavity of the packaging, that is to say on the inner surface of the packaging, or even on the inner and outer surfaces of the packaging.

To do this, the body of the packaging, comprising a bottom and a side wall extending from the bottom, is placed in a tank within which nickel is deposited electrolytically, typically in the order of 300 μm. Such a method has many drawbacks, among which those related to the handling of the packaging bodies in view of the imposing dimensions of the latter, to the material costs since at least the inner surface, or even the inner and outer surfaces, of the packaging are coated and to the associated treatment times. However, such a method is somewhat oversized when only the surfaces of the packaging intended to accommodate the seal(s), which correspond to the so-called “seal bearing” surfaces, are to be protected from corrosion. In addition, it is necessary to perform an additional step of machining the surfaces so as to obtain the required roughness.

Thus, with the aim of treating only the surfaces corresponding to the seal bearings and, in doing so, limiting the material and implementation costs in connection with the dimensional constraints, more targeted (localized) anti-corrosion treatment methods have been proposed.

In particular, this involves a treatment method consisting of depositing, by arc welding, a coating of stainless steel that is localized on said seal bearing surfaces. However, such a method requires not only long welding times, but also additional machining steps.

Document JP S57 93895 U describes a nuclear reactor containment vessel having a flange seal, the sealing surface of which is coated with a plating layer in order to prevent rust. This plating layer is produced by applying, on the surface intended to be coated, a sponge or a brush impregnated with a solution, the sponge and the surface forming the anode and the cathode respectively. However, this document does not specify the composition of the solution or the operating conditions that are implemented to obtain the plating layer.

The aim of the present invention is therefore to overcome the drawbacks of the methods of the prior art and to propose a method for treating packaging for radioactive material against corrosion that is characterized by the deposition of a protective coating that is localized at the level of the surfaces of the packaging more particularly intended to be protected against corrosion such as the seal bearing surfaces mentioned above. This method must also be more economical than those of the prior art, by making this protection against corrosion possible by means of a coating of reduced and constant thickness, without the need to resort to an additional grinding step, for example by machining, said coating.

### DISCLOSURE OF THE INVENTION

These aims, as well as others, are achieved firstly by a method for treating at least one surface of packaging for transporting, warehousing and/or storing radioactive material against corrosion, said at least one surface of the packaging being a surface intended to accommodate at least one seal of the packaging.

According to the invention, this method is implemented by means of an electrolytic device comprising an anode, a cathode and an electrolytic solution, the electrolytic solution comprising at least one metal M in cationic form, and comprises the following successive steps (a) to (d):
(a) bringing at least one applicator impregnated with the electrolytic solution into contact with the surface of the packaging, the packaging forming the cathode and the applicator forming the anode, the anode and the cathode being connected to a power supply,
(b) applying an electrical voltage delivered by the power supply between the cathode and the anode at a value U between 5 V and 30 V,
(c) keeping the electrical voltage at this value U so as to reduce the metal M in cationic form, whereby a layer of the metal M is formed on the surface of the packaging in contact with the applicator, and
(d) removing the applicator from the coated surface of the packaging, the electrolytic solution comprising a nickel sulfamate, a silver salt and/or a copper salt.

The method according to the invention makes it possible to produce an anti-corrosion coating formed by a metal layer consisting of the metal M, this metal M being in this case Ni, Ag or Cu, or by a metal alloy of two, or of all three, of these metals M.

This anti-corrosion coating is deposited electrolytically on a localized surface of the packaging, it being specified that this localized surface corresponds to the surface of the packaging that is in contact with the applicator, the localized surface being electrically conductive. The anti-corrosion coating is formed by electrolytic reduction of the metal M in cationic form in the electrolytic solution impregnating the applicator, it being specified that this electrolytic reduction occurs on the surface of the cathode formed by the packaging. This electrolytic anti-corrosion coating, which has a substantially constant thickness, retains the initial roughness of the localized surface whereon it was applied and therefore does not need to be machined at the end of the method to give it the desired roughness. In addition to being substantially constant, the thickness of the coating is less than that of the anti-corrosion coatings produced by the methods of the prior art and thus makes it possible to accompany any deformations of the body of the packaging. This thickness is advantageously between 20 μm and 100 μm and, preferably, between 40 μm and 70 μm.

It is specified that the expression “between . . . and . . . ” , which has just been cited and that is used in the present application, must be understood as defining not only the values of the interval, but also the values of the limits of this interval.

It can be noted that the surface to be treated may only represent the first portion of a total surface considered, the surface of this first portion being then necessarily electrically conductive. On the other hand, the second portion is then electrically insulated in order to avoid any deposition of metal on this second portion.

As indicated above, step (a) of bringing the packaging into contact with at least one applicator impregnated with the electrolytic solution determines the surface of the packaging whereon the anti-corrosion coating will be deposited electrolytically.

As indicated previously, this surface of the packaging whereon the anti-corrosion coating is deposited electrolytically corresponds at least to the surfaces of the packaging intended to accommodate the seal(s) of the packaging or, in other words, to the seal bearing surfaces.

In an advantageous embodiment, during step (b), the value U of the electrical voltage applied between the cathode and the anode is between 8 V and 15 V.

In one embodiment of the method according to the invention, the surface of the packaging is a surface of revolution whose axis of revolution corresponds to the longitudinal axis of the packaging.

Thus, this surface may be a cylindrical surface that is then parallel to this longitudinal axis of the packaging. This surface may also be in the form of a disk that is then perpendicular to this longitudinal axis of the packaging.

In a first variant of the method according to the invention, during steps (a) to (c), the contact between the surface of the packaging and the applicator is made by a fixed positioning of the applicator on all or part of the surface of the packaging.

In a second variant of the method according to the invention, during steps (a) to (c), the contact between the surface of the packaging and the applicator is made by a relative movement of the applicator with respect to the surface of the packaging.

According to a particular embodiment, the speed of the relative movement of the applicator with respect to the surface of the packaging is between 1 m/min and 40 m/min and, advantageously, between 5 m/min and 30 m/min.

This relative movement may be ensured either by a rotation of the packaging about its longitudinal axis, the applicator then being fixed, or by a rotation of the applicator about the longitudinal axis of the packaging, the packaging being fixed.

This second variant of the method according to the invention has the advantage of implementing an applicator of reduced size compared to the surface of the packaging to be treated against corrosion.

By way of example, the surface of the applicator in contact with the packaging may represent at most 50% and, advantageously, at most 30% of the surface of the packaging to be treated.

A first advantage associated with this reduction in the size of the applicator is to facilitate impregnation of the applicator by the electrolytic solution. A second advantage is to reduce the power of the generator providing the power supply and, in doing so, to reduce the risks of an increase in temperature by the Joule effect of the electrolytic solution.

According to a particular embodiment, particularly when the surface of the packaging to be treated against corrosion is a cylindrical surface, the longitudinal dimension of the applicator is greater than or equal to the longitudinal dimension of this surface of the packaging to be treated.

According to another particular embodiment, particularly when the surface of the packaging to be treated against corrosion is in the form of a disk, the radial dimension of the applicator is greater than or equal to the radial dimension of this surface of the packaging to be treated.

Alternatively, the treatment of the surface may also be obtained by combining the rotation of the packaging with a movement of the applicator in a direction parallel or perpendicular to the axis of the packaging, depending on whether the surface is cylindrical or disk-shaped.

Regardless of whether the first variant or the second variant of the method according to the invention is considered, the applicator is kept in contact with the surface of the packaging to be treated against corrosion during each of steps (a) to (c). This contact is performed by applying a pressure of the applicator to the surface of the packaging to be treated.

This pressure exerted by the applicator on the surface of the packaging is preferably constant, in order to obtain an anti-corrosion coating of substantially constant thickness.

According to a particular embodiment, during these steps (a) to (c), the pressure exerted by the applicator on the surface of the packaging is less than or equal to 20.10⁻⁴ MPa.

Advantageously, this pressure exerted by the applicator on the surface of the packaging is between 10⁻⁴ MPa and 15.10⁻⁴ MPa.

The method according to the invention may implement only one applicator. However, nothing prevents the implementation of two, three, or even more, applicators from being considered, especially since the implementation of a plurality of applicators makes it possible to optimize the wettability of the surface to be treated and, more generally, to reduce the overall duration of the anti-corrosion treatment.

Thus, according to an advantageous embodiment, the method according to the invention implements two applicators, these two applicators being diametrically opposed with respect to the axis of the packaging.

It is specified that throughout the present description, the term “applicator” used in the singular covers both the implementation of a single applicator and of a plurality of applicators.

According to one embodiment, the applicator is made of a conductive material and, preferably, of graphite or nickel.

According to an advantageous embodiment, the applicator is pierced throughout and/or is provided with grooves. These piercings and/or grooves made in the applicator make it possible not only to produce good impregnation of this applicator by the electrolytic solution but also to facilitate the degassing of dihydrogen formed during the electrolytic reduction reaction that occurs on the surface of the packaging (cathode).

As indicated previously, the electrolytic solution that impregnates the applicator comprises at least one metal M in cationic form, the metal M being selected from Ni, Ag and Cu.

The electrolytic solution comprises a nickel sulfamate, a silver salt and/or a copper salt.

Thus, the method according to the invention makes it possible to produce an anti-corrosion coating formed by a metal layer consisting of metallic nickel, silver or copper, by a metal alloy of two of these metals or of these three metals. Such metals and metal alloys are well known to be corrosion resistant.

In the case where the metal M in cationic form is a silver salt, this silver salt may be a silver cyanide.

In the case where the metal M in cationic form is a copper salt, this copper salt may be a copper(II) sulfate or a copper(II) fluoborate.

In a more particularly advantageous alternative embodiment, the electrolytic solution comprises a nickel sulfamate.

Implementing an electrolytic solution comprising a nickel sulfamate makes it possible to obtain a protective coating particularly resistant to corrosion, which withstands thermal shocks during the operation of the packaging, particularly when this packaging is suddenly immersed for the underwater loading of nuclear fuels, and which does not crack under accidental transport conditions, particularly under the effect of an ovalization of the cylindrical body of the packaging and, therefore, of the seal bearing surfaces.

According to a particular embodiment, the temperature of the electrolytic solution impregnated in the applicator is between 15° C. and 80° C.

The method according to the invention therefore has the advantage of being able to be implemented at room temperature, that is to say at a temperature typically between 18° C. and 25° C.

To reduce the overall duration of the anti-corrosion treatment, this temperature of the electrolytic solution impregnated in the applicator may advantageously be brought to a temperature between 30° C. and 70° C. and, preferably, between 50° C. and 70° C.

According to one embodiment, the current density (DI) per unit surface area(S) that is applied during step (c) and that is noted DI/S, is between 4 A·h/dm² and 12 A·h/dm². It is specified that S corresponds to the surface treated during step (c).

Controlling the parameter that is the current density per unit surface area makes it possible to control the final thickness of the metal layer M forming the anti-corrosion coating.

Advantageously, the current density per unit surface area applied during step (c) is between 6 A·h/dm² and 8A·h/dm².

According to one embodiment, the method according to the invention further comprises one or more of the following steps (i) to (iv), steps (i) to (iii) being implemented before step (a) and steps (iv) and (v) being implemented after step (d):
(i) applying masking to a surface of the packaging other than the surface to be treated,
(ii) applying a cleaning solution to the surface of the packaging followed by rinsing with water,
(iii) applying a solution for activating the surface of the packaging followed by rinsing with water,
(iv) rinsing the coated surface of the packaging with water, and
(v) removing the masking.

Implementing step (i) makes it possible to protect one or more surfaces of the packaging that are not intended to be treated by the method according to the invention. This step may also make it possible to protect a specific portion of the surface to be treated and thus perform a deposition only on the portion of the unprotected surface.

Implementing one and/or the other of steps (ii) and (iii) makes it possible to optimize the subsequent adhesion of the metal layer M constituting the anti-corrosion coating. In a particular embodiment, the cleaning solution of step (ii) comprises a sodium salt. This sodium salt is preferably selected from sodium hydroxide and sodium carbonate.

In a particular embodiment, the activation solution of step (iii) comprises an inorganic acid that is, preferably, sulfuric acid.

In a particular embodiment, one and/or the other of steps (ii) and (iii) may be conducted electrolytically; the cleaning and/or activation solutions then constitute the electrolytic solutions of an electrolytic device wherein the cathode is formed by the packaging and the anode by at least one applicator impregnated with one and/or the other of these solutions, by analogy with the anti-corrosion treatment method described above.

The method according to the invention makes it possible to treat at least one surface of packaging for transporting, warehousing and/or storing radioactive material against corrosion, in particular the surface(s) intended to accommodate at least one seal.

Such packaging for transporting, warehousing and/or storing radioactive material typically comprises a packaging body, consisting of a bottom and a side wall extending from the bottom, as well as a system for closing this body.

The surface of the packaging coated by the treatment method according to the invention corresponds to at least the surface for accommodating at least one seal ensuring the sealing between the body and the closure system in the closed position of the packaging.

### BRIEF DESCRIPTION OF THE FIGURES

Other advantages, aims and particular features of the present invention will become apparent from the following non-limiting description of at least one particular embodiment of the method according to the invention, with regard to the appended drawings, wherein:

FIG. 1 is a schematic perspective view of packaging for transporting, warehousing and/or storing radioactive material;

FIG. 2 is a schematic sectional view of the body of the packaging shown in FIG. 1;

FIG. 3 is an enlargement of the upper portion of the packaging body; and

FIG. 4 is a front view of the upper end of the body of the packaging, in particular of the surface S2 marked in FIG. 3 and provided with two anodes.

### DETAILED PRESENTATION OF A PARTICULAR EMBODIMENT

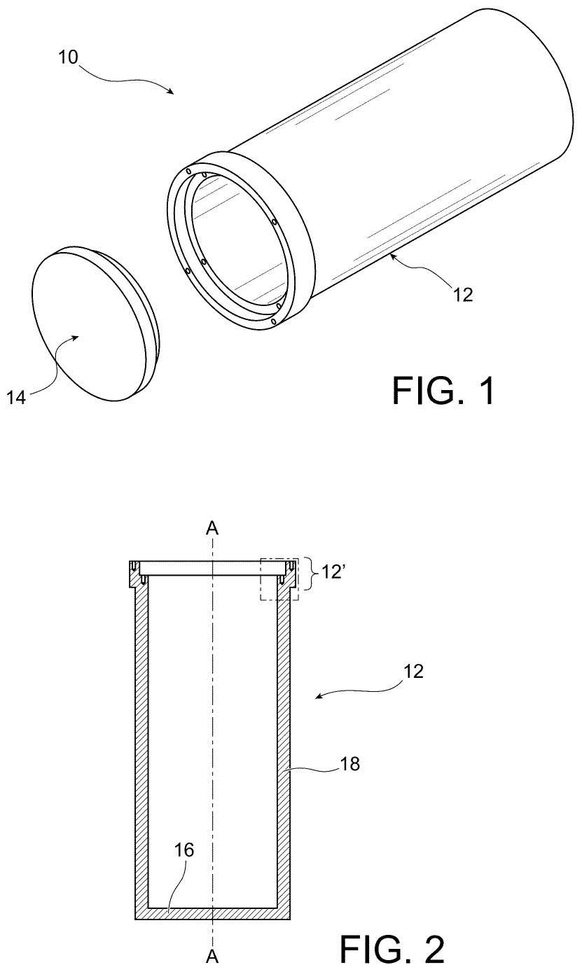

The method according to the invention is implemented on the packaging for transporting, warehousing and/or storing radioactive material 10 shown schematically in FIG. 1.

The packaging 10 comprises a cylindrical body 12 as well as a closure system or lid 14.

As illustrated in FIG. 2, the body 12 of the packaging 10 comprises a bottom 16 and a side wall 18 extending from the bottom 16. The body 12 is centered around the longitudinal axis A and has a circular section.

The upper portion 12′ of the body 12, which corresponds to the portion opposite the bottom 16, is intended to accommodate at least one seal mounted on the inner surface of the lid (not shown). This or these seals make it possible to ensure sealing between the body 12 and the closure system 14 in the closed position of the packaging 10.

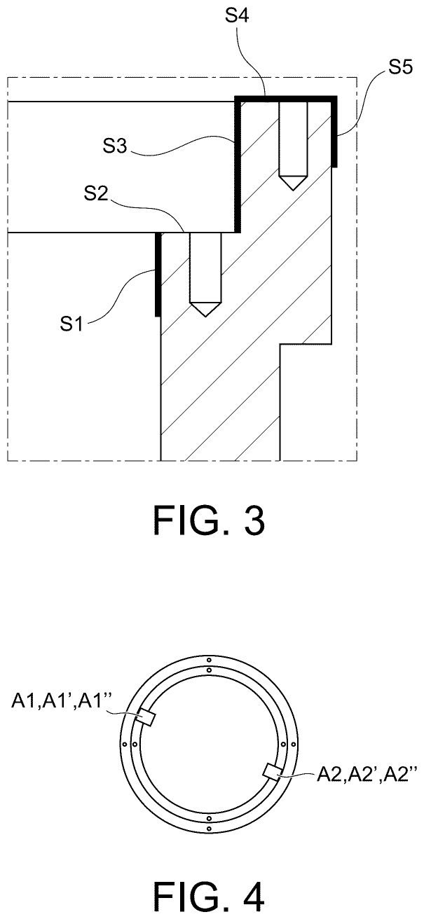

With reference to FIG. 3, which corresponds to an enlargement of the upper portion 12′ of the body 12, it is observed that this upper portion 12′ comprises the surfaces marked with the references S1, S2, S3, S4 and S5.

The surfaces S1, S3 and S5 on the one hand, and S2 and S4 on the other hand, correspond to longitudinal (cylindrical) and radial (disk-shaped) surfaces, respectively, with respect to the longitudinal axis A.

If all of the surfaces S1 to S5 are treated by the anti-corrosion treatment method in accordance with the invention, the description below will relate to the treatment of the surface S2 alone.

The surface S2 has an annular shape and corresponds to the surface for accommodating two seals (not shown) disposed on the lower surface of the lid 14 of the packaging 10 and making it possible to ensure sealing between the body 12 and the lid 14 in the closed position of the body 12 of the packaging 10.

Typically, the surface S2 to be treated has a surface area of about 5,840 cm² and a radial dimension in the order of 10 cm.

In the first step (i) prior to the anti-corrosion treatment of the surface S2, the other surfaces S1, S3, S4 and S5 are masked by applying a protective coating.

Such a protective coating may be formed by an adhesive tape of the aluminum tape type, by a paint and/or by a peelable varnish. In FIG. 3, these masked surfaces S1 and S3 to S5 are marked by a line thicker than that marking the surface S2.

In a second step (ii), a step of cleaning the surface S2 electrolytically is performed.

To do this, the surface S2 is brought into contact with two graphite applicators, or anodes, A1 and A2 each having a surface area of 228 cm² (19 cm×12 cm), the contact area between the applicators A1, A2 and the surface S2 therefore representing about 4% of the total surface area of S2.

These applicators A1 and A2 are impregnated with a cleaning solution comprising sodium hydroxide and the temperature of which is between 15° C. and 40° C. The impregnation of the applicators A1, A2 is maintained during step (ii) by means of a continuous supply, by means of a hose, at a flow rate greater than 4 L/min of cleaning solution.

These applicators A1 and A2 are disposed diametrically opposite one another as illustrated in FIG. 4.

The body 12 is then rotated about the longitudinal axis A thereof in such a way as to have a relative movement between the anodes A1, A2 and the surface S2 of about 15 m/min.

An electrical voltage is subsequently applied between the surface S2 and the anodes A1, A2 at a value between 8 V and 10 V.

When the current density reaches a value in the order of 22 Ah, the electrical voltage is cut off, the anodes A1, A2 are removed and the rotation of the body 12 is interrupted. In a third step (iii), a step of electrolytically activating the surface S2 that was cleaned during step (ii) is performed.

To do this, the surface S2 is brought in contact with two other applicators, or anodes, A1′ and A2′ specific for this step (iii), impregnated with an activation solution comprising sulfuric acid and the temperature of which is between 15° C. and 40° C. The impregnation of the applicators A1′, A2′ is maintained during step (iii) by means of a continuous supply, by means of a hose, at a flow rate of more than 3 L/min of activation solution.

As in step (ii), during step (iii), the applicators A1′ and A2′ are disposed diametrically opposite one another (FIG. 4).

An electrical voltage in the order of 8 V is subsequently applied between the surface S2 and the anodes A1′, A2′.

The body 12 is subsequently rotated about the longitudinal axis A thereof in such a way as to have a relative movement between the anodes A1′, A2′ and the surface S2 of about 15 m/min.

When the current density reaches a value in the order of 32 Ah, the electrical voltage is cut off, the anodes A1′, A2′ are removed and the rotation of the body 12 is interrupted.

In a fourth step, the anti-corrosion treatment method in accordance with the invention is implemented making it possible to perform a metal nickel deposition electrolytically on the surface S2 that was activated during step (iii).

To do this, the surface S2 is brought into contact with two new applicators, or anodes, A1″ and A2″ impregnated with a solution comprising nickel sulfamate and having a temperature between 50° C. and 70° C. The impregnation of the applicators A1″, A2″ is maintained during this fourth step by means of a continuous supply, by means of a hose, at a flow rate of more than 10 L/min of nickel sulfamate solution.

As in steps (ii) and (iii), in this fourth step, the applicators A1″ and A2″ are disposed diametrically opposite one another (FIG. 4).

An electrical voltage in the order of 15 V and an amperage of about 200 A per anode are subsequently applied between the surface S2 and the anodes A1″, A2″.

The body 12 is subsequently rotated about the longitudinal axis A thereof in such a way as to have a relative movement between the anodes A1″, A2″ and the surface S2 of about 15 m/min.

When the current density reaches a value in the order of 400 Ah, which corresponds to a value of current density per unit surface area of 6.8A·h/dm², the electrical voltage is cut off, the anodes A1″, A2″ are removed and the rotation of the body 12 is interrupted.

At the end of this fourth step, the surface S2 is entirely coated with a metallic nickel layer having a constant thickness in the order of 50 μm.

In a fifth step, the masking of the untreated surfaces S1, S3, S4 and S5 is removed, in order to proceed with any subsequent treatment of one or more of these surfaces. Each of the second, third and fourth steps may be performed automatically.

What is claimed is:

1. A method for treating at least one surface of packaging for transporting, warehousing and/or storing radioactive material against corrosion by means of an electrolytic device comprising an anode, a cathode and an electrolytic solution, said at least one surface of the packaging being a surface intended to accommodate at least one seal of the packaging and the electrolytic solution comprising at least one metal M in cationic form, this method comprising the following successive steps (a) to (d):
(a) bringing at least one applicator impregnated with the electrolytic solution into contact with the surface of the packaging, the packaging forming the cathode and the applicator forming the anode, the anode and the cathode being connected to a power supply,
(b) applying an electrical voltage delivered by the power supply between the cathode and the anode at a value U between 5 V and 30 V and, advantageously, between 8 V and 15 V,
(c) keeping the electrical voltage at this value U so as to reduce the metal M in cationic form, whereby a layer of the metal M, having a thickness advantageously between 20 μm and 100 μm and, preferably, between 40 um and 70 μm, is formed on the surface of the packaging in contact with the applicator and
(d) removing the applicator from the coated surface of the packaging,
the electrolytic solution comprising a nickel sulfamate.

2. The method according to claim 1, wherein the surface of the packaging is a surface of revolution, for example a cylindrical surface or a disk-shaped surface.

3. The method according to claim 2, wherein, during steps (a) to (c), the contact between the surface of the packaging and the applicator is performed by a relative movement of the applicator with respect to the surface of the packaging, the relative movement being ensured either by a rotation of the packaging about its longitudinal axis, the applicator being fixed, or by a rotation of the applicator about the longitudinal axis of the packaging, the packaging being fixed.

4. The method according to claim 3, wherein the speed of the relative movement of the applicator with respect to the surface of the is between 1 m/min and 40 m/min and, advantageously, between 5 m/min and 30 m/min.

5. The method according to claim 1, wherein, during steps (a) to (c), the pressure exerted by the applicator on the surface of the packaging is less than or equal to 20.10⁻⁴ MPa and, advantageously, between 10⁻⁴ MPa and 15.10⁻⁴ MPa.

6. The method according to claim 1, wherein the surface of the applicator in contact with the packaging represents at most 50% and, advantageously, at most 30% of the surface to be treated.

7. The method according to claim 2, wherein the radial dimension of the applicator greater than or equal to the radial dimension of the surface to be treated.

8. The method according to claim 2, wherein the longitudinal dimension of the applicator greater than or equal to the longitudinal dimension of the surface to be treated.

9. (canceled)

10. (canceled)

11. The method according to claim 1, wherein the applicator is made of a conductive material, preferably graphite or nickel, and is advantageously pierced throughout and/or is provided with grooves.

12. The method according to claim 1, wherein two applicators diametrically opposed with respect to the axis of the packaging are implemented.

13. The method according to claim 1, wherein the temperature of the electrolytic solution impregnated in the applicator is between 15° C. and 80° C., advantageously between 30° C. and 70° C. and, preferably, between 50° C. and 70°C.

14. The method according to claim 1, wherein the current density applied during step (c) is between 4 A·h/dm² and 12 A·h/dm², and, advantageously, between 6 A·h/dm² and 8A·h/dm².

15. The method according to claim 1, further comprising one or more of the following steps (i) to (v), steps (i) to (iii) being implemented before step (a) and steps (iv) and (v) being implemented after step (d):
(i) applying masking to a surface of the packaging (10) other than the surface to be treated,
(ii) applying a cleaning solution to the surface of the packaging followed by rinsing with water,
(iii) applying a solution for activating the surface of the packaging followed by rinsing with water,
(iv) rinsing the coated surface of the packaging with water, and
(v) removing the masking.

16. The method according to claim 1, wherein, the packaging comprising a body, this body being formed by a bottom and a side wall extending from the bottom, and a system for closing the body, the coated surface of the packaging corresponds to at least the surface for accommodating at least one seal ensuring the sealing between the body and the closure system in the closed position of the packaging.
